(19) United States
(12) Patent Application Publication
(10) Pub. No.: US 2008/0084059 A1
(43) Pub. Date: Apr. 10, 2008

(54) PIPE-CONNECTION MOULDED PART HAVING THERMAL INSULATION AND METHOD OF PRODUCING THE PIPE-CONNECTION MOULDED PART

(75) Inventors: Max Meier, Luterkofen (CH); Harald Muckenschnabel, Singen (DE)

Correspondence Address: BACHMAN & LAPOINTE, P.C., 900 CHAPEL STREET, SUITE 1201, NEW HAVEN, CT, 06510, US

(73) Assignee: GEORG FISCHER ROHRLEITUNGSSYSTEME AG, Schaffhausen (CH)

(21) Appl. No.: 11/865,733

(22) Filed: Oct. 2, 2007

(30) Foreign Application Priority Data
Oct. 5, 2006 (EP) 06 121 797.2
Oct. 30, 2006 (EP) 06 123 155.1

(51) Int. Cl. F16L 59/16

(52) U.S. Cl. 285/47; 29/592

(57) ABSTRACT

A pipe-connection moulded part comprising an inner pipe part, an insulating layer and an outer casing of plastic, wherein the outer casing and the insulating layer are formed from the same plastic, for example polyurethane. A method of producing the pipe-connection moulded part is also proposed.

### BACKGROUND OF THE INVENTION

The invention relates to a pipe-connection moulded part having thermal insulation, comprising an inner pipe part, an insulating layer and an outer casing.

In pipeline construction, in particular in applications in which good insulation of the medium relative to the environment is necessary, such as, for example, in pipeline systems for the transport of refrigerant media, pre-insulated pipeline sections are being increasingly used. A highly suitable material for insulating refrigerant pipelines is reactive foamed polyurethane (=PUR). As protection against penetrating water, which has an adverse effect on the insulating effect of the foam, and as protection against mechanical damage to the insulating layer, the insulated pipelines are provided with an outer casing.

An outer pipe or a tubular outer casing is arranged concentrically around the pipeline at a uniform distance from the outer wall of the pipeline. The tubular space between the inner wall of the casing and the outer wall of the pipeline is completely filled with polyurethane foam. The polyurethane foam is injected as a reactive foam-forming liquid and the foam produced cures. The foam readily adheres to the surfaces of the pipeline and of the outer casing and also gives the pipeline pre-insulated in this way higher rigidity.

The production of pre-insulated pipelines is relatively complicated, since a plurality of components having different properties have to be brought together. The installation of pipe branches in pre-insulated pipeline networks is likewise complicated, since, in various processing steps, the insulating casing and the pipeline have to be exposed, connected to the branching pipeline and re-insulated again.

EP 059 017 B1 discloses an insulated pipe branch connection of the generic type. A specially designed insulating branch pipe part is pushed over the branch pipe part. To this end, the insulating branch pipe part is displaceably arranged around the branching pipe and has a longitudinal slot running in the direction of the main pipeline. Once the insulating branch pipe part has been pushed over the branch pipe part, the longitudinal slot is held in a tightly clamped manner by specially designed insulating casing parts which can be displaced over the main pipeline. Finally, the pipe branch is closed in a vapour-tight manner using sleeves consisting of a heat-shrinkable tubing.

Based on this prior art, the object of the invention is to specify a pipe-connection moulded part having thermal insulation which can also be produced in a simple manner in the case of a branched pipeline layout, ensures the best possible insulation and as low a thermal expansion as possible and has high rigidity against deformation and is designed to be as watertight and as vapour-tight as possible. During the production of the pipe-connection moulded part, the outer casing should cause as little compression of or damage to the insulating layer as possible.

### SUMMARY OF THE INVENTION

The object is achieved by a pipe-connection moulded part having thermal insulation, comprising an inner pipe part, an insulating layer and an outer casing of plastic, characterized in that the outer casing and the insulating layer are formed from the same material, for example polyurethane.

The object is also achieved by a method of producing a pipe-connection moulded part.

It is of advantage that the pipe-connection moulded part has as high a rigidity as possible. This is achieved by virtue of the fact that a second polyurethane layer is in contact with the first polyurethane foam layer, can be connected to the outer side of the first polyurethane foam layer and is formed from a pourable polyurethane casting system. This is also achieved by virtue of the fact that the encapsulation of the pipe-connection moulded part with the first polyurethane foam layer and the casting of the second polyurethane casting compound around the first polyurethane foam layer are carried out one after the other in two very similar moulds or in the same mould on a similar moulding unit.

In particular in the case of complicated pipe elbows, pipe bends and/or pipe branches which would have to be assembled from the individual parts only with a great deal of, often, manual, labour on various units, a lot of time and labour can be saved by the production of the insulating layer and of the outer casing in the same unit.

### BRIEF DESCRIPTION OF THE DRAWINGS

An exemplary embodiment of the invention is described with reference to the figures. In the drawing:

FIG. 1 shows a section through a pipe-connection moulded part according to the invention,

FIG. 2 shows a section through a mould for producing the pipe-connection moulded part from FIG. 1 according to a first method step, and

FIG. 3 shows a section through a further mould for producing the pipe-connection moulded part from FIG. 1 according to a following method step.

### DETAILED DESCRIPTION

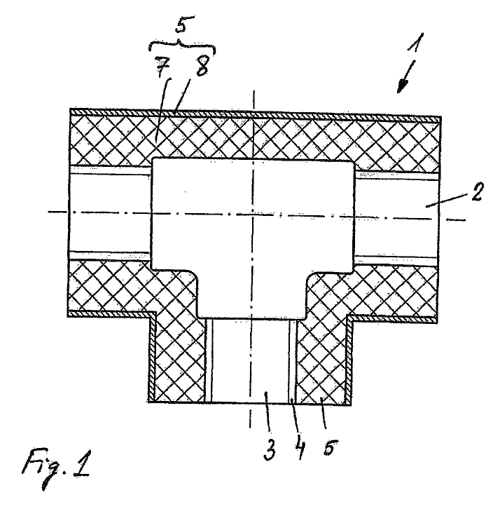

In FIG. 1, a pipe-connection moulded part 1 having thermal insulation is shown sectioned along the centre line. The pipe-connection moulded part 1 from FIG. 1 is assembled, for example, from a main pipeline 2 having a pipe branch 3. As viewed from inside to outside, the pipe-connection moulded part 1 is composed of an inner pipe part 4, for example made of an acrylonitrile-butadiene-styrene copolymer (=ABS), an insulating layer 7 and an outer casing 8.

The insulation of the pipe-connection moulded part 1 is composed of a first polyurethane foam layer 7 which is produced from a closed-cell foam and of a second polyurethane layer 8 which is produced from a pourable polyurethane system. The outer casing 8 may also be produced from another plastic system pourable under as low a pressure as possible. It is in particular important here that the outer casing, during the production, for example by casting, does not compress and does not damage the inner insulating layer, that is to say the first polyurethane foam layer 7. The outer casing 8 should exert as little pressure as possible on the insulating layer 7. The outer casing 8 may also be firmly connected to the first polyurethane foam layer 7 subsequently by a shrinkage process. The polyurethane foam layers 7, 8 are firmly adhesively bonded to one another and are connected to the inner pipe part 4. The pipe-connection moulded part 1 is produced in one piece and has high rigidity.

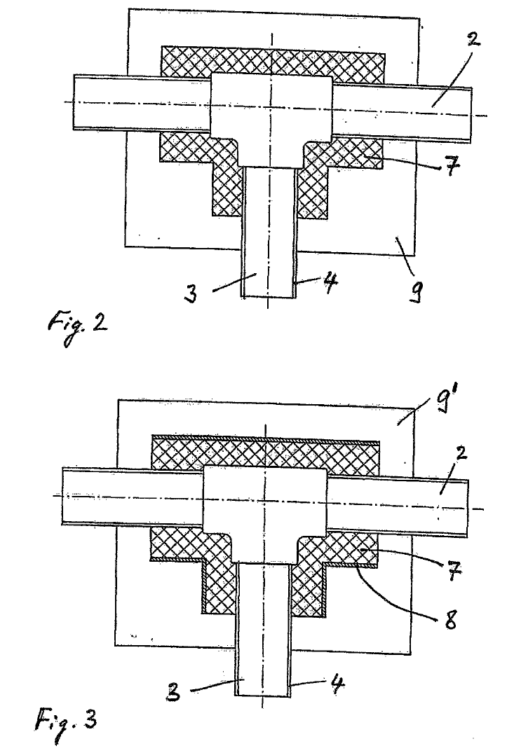

The pipe-connection moulded part 1 according to two successive method steps of the production method is shown sectioned in FIGS. 2 and 3. The pipe-connection moulded part 1 is produced in a combined foaming and casting process in a first mould 9. An inner pipe part 4 having a pipe branch 3 is inserted into the mould 9. The inner pipe part 4 may also be made of metal instead of a plastic. The clearance space between the inner pipe part 4 and the inner wall of the mould 9 is filled and foamed in a first method step with a reactive polyurethane foam forming closed cells.

Then, after the first polyurethane foam layer 7 has fully reacted, the pipe-connection moulded part 1 is put into a second mould 9′ which is only slightly larger than the first mould 9. In the second mould 9′, a second layer 8 of a polyurethane casting compound or of another non-foaming plastic casting system or of a plastic casting system which does not foam to a considerable degree is inserted into the mould 9′. The material for the casting compound of the outer casing 8 is selected in such a way that the outer casing 8 exerts only a small pressure on the insulating layer 7. Instead of a polyurethane system, a poly epoxy system or another thermoplastic system, for example, may also be selected. In principle, if there is a slight difference in the dimensions of the first and the second mould 9, 9′, a single mould having adjustable inner walls is also feasible.

The first polyurethane foam layer 7 and the second polyurethane casting compound 8 join together by adhesion and form an insulating casing 5 which ensures good thermal insulation on the one hand and sufficient rigidity and strength of the pipe-connection moulded part 1 on the other hand. The first polyurethane foam layer 7 is, for example, two to six times as thick as the outer casing 8 consisting of a polyurethane casting compound 8 or of a casting resin. The insulating layer 7 of polyurethane foam has, for example, a density which is substantially less than 10% of the density of the outer casing 8 consisting of the polyurethane casting compound.

The pipe-connection moulded part 1 is used, for example, in pipeline systems for refrigerants. The pipe-connection moulded part 1 is distinguished by very simple production, for the same unit can be used for the production of the insulating layer and the outer casing. As low a thermal expansion as possible is achieved through the use of the same materials for insulating layer and casing. The outer casing is watertight and the pipe-connection moulded part has high rigidity. In particular in pipe-connection moulded parts having pipe elbows or pipe branches, this production method saves more time and labour than previous production methods. Orienting the inner pipe 4 with respect to the outer casing 8 and/or delivery in a further mould are dispensed with. The shrinking of the heat-shrinkable tubing on a shrink-fit unit is dispensed with.

1. Pipe-connection moulded part comprising an inner pipe part, an insulating layer and an outer casing of plastic, wherein the outer casing and the insulating layer are formed of the same material.

2. Pipe-connection moulded part according to claim 1, wherein the material is polyurethane.

3. Pipe-connection moulded part according to claim 1, wherein the insulating layer is in contact with the inner pipe part, is connected to an outer side of the inner pipe part and is formed as a foam.

4. Pipe-connection moulded part according to claim 1, wherein the insulating layer is in contact with an inner pipe part, is connected to the outer side of the inner pipe part (4) and is formed as a closed-cell polyurethane foam.

5. Pipe-connection moulded part according to claim 4, wherein the outer casing is formed of a pourable material compatible with the insulating layer.

6. Pipe-connection moulded part according to claim 4, wherein the outer casing is in contact with the insulating layer, is connected to an outer side of the foam insulating layer and is formed of a pourable foam material.

7. Pipe-connection moulded part according to claim 1, wherein the outer casing is in contact with the insulating layer, and is connected to an outer side of the foam insulating layer.

8. Pipe-connection moulded part according to claim 1, wherein the outer casing is in contact with the insulating layer, is connected to an outer side of the insulating foam layer and is formed of a non-foamed polyurethane material.

9. Pipe-connection moulded part according to claim 4, wherein the inner pipe part is formed from an acrylonitrile-butadiene-styrene copolymer (=ABS).

10. Pipe-connection moulded part according to claim 4, wherein the inner pipe part is formed from a plastic selected from the group consisting of polyethylene, polypropylene and polyvinylchloride.

11. Pipe-connection moulded part according to claim 4, wherein the pipe-connection moulded part has at least one pipe branch.

12. Pipe-connection moulded part according to claim 4, wherein the pipe-connection moulded part has at least one pipe elbow.

13. Method of producing a pipe-connection moulded part of claim 3 comprising the steps of:
a) inserting the inner pipe part into a first mould,
b) foam-encapsulating the inner pipe part with a first insulating layer, consisting of a foam system,
c) inserting the foam-encapsulated inner pipe part with the insulating layer in a second mould which is slightly larger than the first mould, and
d) casting an outer casing around the insulating layer, said outer casing consisting of a pourable, non-foaming material system compatible with the insulating layer for producing a low internal tool pressure, without the insulating layer being damaged or compressed by the outer casing in the process.

14. Method of producing a pipe-connection moulded part according to claim 13, wherein the method steps b), c) and d) are carried out successively in the same mould.

15. Method of producing a pipe-connection moulded part according to claim 13, wherein the foam system is a closed-cell polyurethane foam system.
